(19) United States
(12) Patent Application Publication
(10) Pub. No.: US 2026/0097939 A1
(43) Pub. Date: Apr. 9, 2026

(54) MOUNTING DEVICE

(71) Applicant: FUJI CORPORATION, Chiryu (JP)

(72) Inventors: Sota MIZUNO, Okazaki-shi (JP); Shigeyoshi INAGAKI, Yokkaichi-shi (JP)

(73) Assignee: FUJI CORPORATION, Chiryu (JP)

(21) Appl. No.: 19/115,861

(22) PCT Filed: Oct. 25, 2022
(86) PCT No.: PCT/JP2022/039661

§ 371 Date: Mar. 27, 2025

(51) Int. Cl. B66F 9/075; B66F 9/06

(52) U.S. Cl. CPC B66F 9/07504; B66F 9/063; B66F 9/07527

(57) ABSTRACT

An attachment device is detachably attached to an automatic conveyance device, the attachment device including: a shielding member configured to shield a structural member configured to operate or display an operation state of the automatic conveyance device in a state in which the attachment device is attached to the automatic conveyance device.

### TECHNICAL FIELD

The present disclosure relates to an attachment device detachably attached to an automatic conveyance device.

### BACKGROUND ART

Patent Literature below describes an attachment device detachably attached to an automatic conveyance device.

### CITATION LIST

### Patent Literature

Patent Literature 1: JP-A-2019-91770

### BRIEF SUMMARY

### Technical Problem

An object of the present description is to improve practicality of an attachment device detachably attached to an automatic conveyance device.

### Solution to Problem

In order to achieve the above-described object, the present description discloses an attachment device to be detachably attached to an automatic conveyance device, the attachment device including: a shielding member configured to shield a structural member configured to operate or display an operation state of the automatic conveyance device in a state in which the attachment device is attached to the automatic conveyance device.

### Advantageous Effects

In the attachment device of the present description, the structural member, which operates or displays the operation state of the automatic conveyance device in a state in which the attachment device is attached to the automatic conveyance device, is shielded. As a result, in a state in which the attachment device is attached to the automatic conveyance device, for example, it is possible to hide the structural member that may confuse a worker, and the practicality of the attachment device is improved.

### BRIEF DESCRIPTION OF DRAWINGS

FIG. 1 is a perspective view illustrating a board work system.

FIG. 2 is a perspective view illustrating a mounting device and a feeder exchange device.

FIG. 3 is a perspective view illustrating a tape feeder.

FIG. 4 is a perspective view illustrating a storage rack.

FIG. 5 is a perspective view illustrating a conveyance cart in a state of being mounted on an automatic conveyance device.

FIG. 6 is a perspective view illustrating the automatic conveyance device.

FIG. 7 is a perspective view illustrating the conveyance cart.

FIG. 8 is a perspective view illustrating the conveyance cart.

FIG. 9 is a perspective view illustrating the conveyance cart in a state of being mounted on the automatic conveyance device.

FIG. 10 is a side view illustrating a feeder storage and the conveyance cart in a state of being mounted on the automatic conveyance device.

FIG. 11 is a schematic view illustrating the board work system and a rack management device.

FIG. 12 is an enlarged perspective view illustrating the conveyance cart in a state of being mounted on the automatic conveyance device.

FIG. 13 is an enlarged perspective view illustrating the conveyance cart in a state of being mounted on the automatic conveyance device.

FIG. 14 is a perspective view illustrating a shielding member provided in a lock mechanism.

FIG. 15 is a schematic view illustrating a connector provided in the lock mechanism.

FIG. 16 is a schematic view illustrating the connector provided in the lock mechanism.

### DESCRIPTION OF EMBODIMENTS

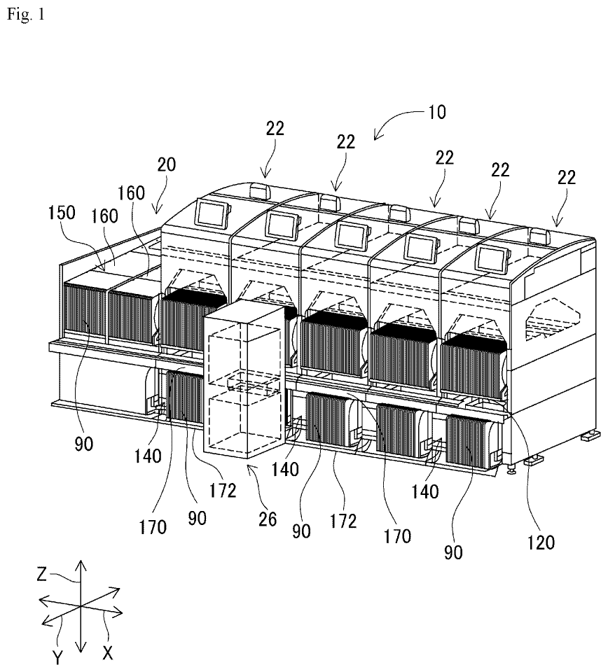

FIG. 1 illustrates board work system 10. System 10 illustrated in FIG. 1 is a system for mounting an electronic component on a circuit board. Board work system 10 includes one feeder storage 20, five mounting devices 22, and one feeder exchange device 26. One feeder storage 20 and five mounting devices 22 are disposed in one row in a state in which one feeder storage 20 and five mounting devices 22 are adjacent in this order. Feeder exchange device 26 is disposed on a front side (front side in FIG. 1) of feeder storage 20 and mounting device 22. In the following description, a direction in which feeder storage 20 and mounting device 22 are arranged is referred to as an X direction, a horizontal direction perpendicular to the X direction is referred to as a Y direction, and a direction orthogonal to the X direction and the Y direction is referred to as a Z direction. In the X direction, a side on which feeder storage 20 is disposed is referred to as an upstream side, and a side on which mounting device 22 is disposed is referred to as a downstream side.

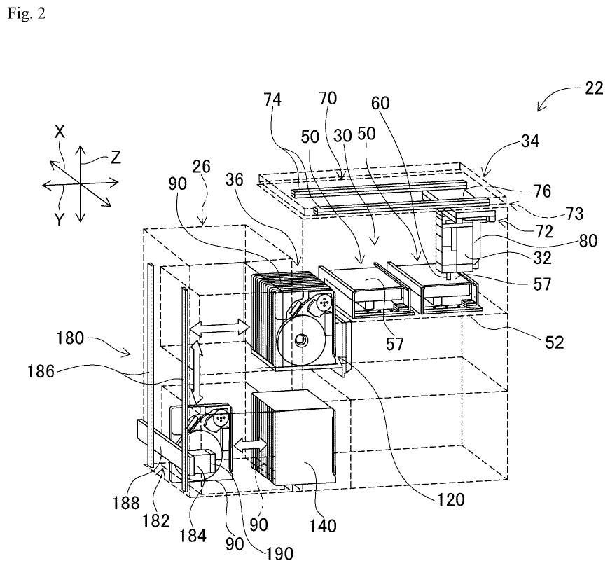

Five mounting devices 22 have substantially the same configuration as each other, and each of five mounting devices 22 includes conveyance device 30, mounting head 32, mounting head moving device (hereinafter, abbreviated as a “moving device” in some cases) 34, and supply device 36, as illustrated in FIG. 2.

Conveyance device 30 includes two conveyor devices 50. Two conveyor devices 50 are disposed on base 52 to extend parallel to each other and extend in the X direction. Each of two conveyor devices 50 conveys circuit board 57 supported by each conveyor device 50 in the X direction by an electromagnetic motor (not illustrated). In addition, each conveyor device 50 includes a board holding device (not illustrated), and fixedly holds circuit board 57 at a predetermined position.

Mounting head 32 mounts the electronic component on circuit board 57. Specifically, mounting head 32 includes suction nozzle 60 provided on a lower end surface thereof. Suction nozzle 60 communicates with a positive-negative pressure supply device (not illustrated) through positive pressure air and negative pressure air passages. Suction nozzle 60 picks up and holds the electronic component by using the negative pressure, and separates the held electronic component by using the positive pressure. Mounting head 32 includes a nozzle lifting and lowering device (not illustrated) that lifts and lowers suction nozzle 60. The nozzle lifting and lowering device changes a position of the electronic component held by mounting head 32 in an up-down direction.

Moving device 34 is a device that moves mounting head 32 to any position on base 52. Specifically, moving device 34 includes X-direction slide mechanism 70 and Y-direction slide mechanism 72. Y-direction slide mechanism 72 is disposed on beam 73 suspended on base 52, and includes pair of Y-direction guide rails 74. Pair of Y-direction guide rails 74 are disposed to extend in the Y direction. Meanwhile, X-direction slide mechanism 70 includes X-direction guide rail 76, and X-direction guide rail 76 is held by pair of Y-direction guide rails 74 to extend in the X direction. Y-direction slide mechanism 72 includes an electromagnetic motor (not illustrated), and X-direction guide rail 76 moves to any position in the Y direction by driving of the electromagnetic motor. X-direction guide rail 76 holds slider 80 to be movable along an axis of X-direction guide rail 76. X-direction slide mechanism 70 includes an electromagnetic motor (not illustrated), and slider 80 moves to any position in the X direction by driving of the electromagnetic motor. Mounting head 32 is mounted on slider 80. With such a structure, mounting head 32 moves to any position on base 52 by using moving device 34.

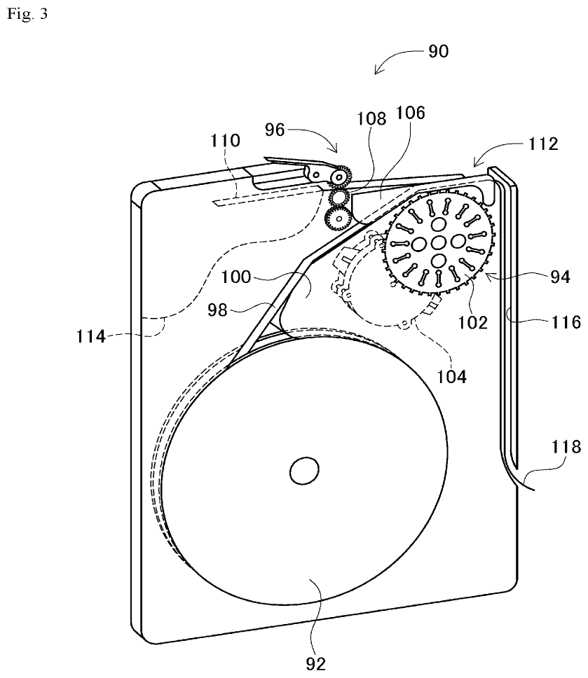

Supply device 36 is disposed at an end portion on a front side of base 52, and includes multiple tape feeders 90. As illustrated in FIG. 3, each tape feeder 90 includes reel 92, feed-out device 94, and peeling device 96, and supplies the electronic component at an end portion of an upper surface. Specifically, taped component 98 is wound on reel 92, and taped component 98 is pulled out from reel 92 onto tape guide 100. Taped component 98 is a taped electronic component, and is formed with feed holes (not illustrated) at predetermined pitches. Sprocket 102 of feed-out device 94 meshes with the feed hole. Sprocket 102 is rotated by electromagnetic motor 104. With such a structure, taped component 98 is fed out toward a supply position.

In addition, peeling device 96 includes film peeling mechanism 106 and gear mechanism 108. Film peeling mechanism 106 is a mechanism for peeling off top film 110 from taped component 98, and is disposed in front of opening 112 formed in an upper surface end portion of tape feeder 90. Gear mechanism 108 is a mechanism that pulls top film 110 peeled off from taped component 98 into film recovery section 114. With such a structure, top film 110 is peeled off from taped component 98, so that the electronic component accommodated in taped component 98 is exposed at opening 112, and the exposed electronic component is picked up and held by suction nozzle 60 of mounting head 32. That is, opening 112 is an electronic component supply position of tape feeder 90. Tape guide passage 116 is formed downward on a side surface of opening 112 in a direction of feeding out taped component 98. Waste tape 118 in which the electronic component is extracted from taped component 98 is discharged through tape guide passage 116.

As illustrated in FIG. 2, tape feeder 90 is detachable from tape feeder holding stand 120 fixedly provided at the end portion on the front side of base 52. Multiple rails (not illustrated) extending in the Y direction are formed to be arranged in the X direction on tape feeder holding stand 120, and tape feeder 90 is detachably mounted on each rail.

Storage case 140 is disposed below tape feeder holding stand 120. As in tape feeder holding stand 120, multiple rails (not illustrated) extending in the Y direction are formed to be arranged in the X direction in storage case 140, and tape feeder 90 is detachably mounted on each rail.

As illustrated in FIG. 1, storage space 150 is formed in feeder storage 20 at the same height as tape feeder holding stand 120 of mounting device 22. Storage space 150 is a space for storing storage rack 160. As illustrated in FIG. 4, storage rack 160 has a box shape in which a front surface is open. A height dimension of an interior of storage rack 160 having the box shape is slightly larger than a height dimension of tape feeder 90, and a depth dimension of the interior of storage rack 160 is slightly larger than a depth dimension of tape feeder 90. A width dimension of the interior of storage rack 160 is larger than a width dimension of tape feeder 90 by N times (for example, 30 times). N tape feeders 90 can be stored in an arranged manner in storage rack 160 having such a shape. Multiple (N) rails 164 are formed on a lower surface of top plate 162 of storage rack 160 to extend in a front-rear direction. Therefore, by fitting an upper end of tape feeder 90 into rails 164 and pushing tape feeder 90 into storage rack 160, tape feeder 90 is stored in a state in which tape feeder 90 is positioned inside storage rack 160.

An inner dimension in the depth direction of storage space 150 is slightly larger than an outer dimension in the depth direction of storage rack 160, and an inner dimension in the width direction of storage space 150, that is, an inner dimension in the X direction is slightly larger than twice an outer dimension in the width direction of storage rack 160. An upper side of storage space 150 is open. Therefore, as illustrated in FIG. 1, two storage racks 160 can be stored in storage space 150 in an arranged manner in the X direction.

Further, feeder exchange device 26 performs work of exchanging tape feeder 90 on feeder storage 20 and each of five mounting devices 22. Specifically, upper guide rail 170 and lower guide rail 172 are disposed to extend in the X direction on the front surfaces of feeder storage 20 and five mounting devices 22. Feeder exchange device 26 is held by upper guide rail 170 and lower guide rail 172 to be slidable in the X direction, and moves to any position in the X direction by the driving of an electromagnetic motor (not illustrated).

As illustrated in FIG. 2, feeder exchange device 26 includes lifting and lowering device 180, horizontal moving device 182, and clamp mechanism 184. Lifting and lowering device 180 includes pair of Z-direction guide rails 186, and pair of Z-direction guide rails 186 are disposed to extend in the Z direction on the front side of tape feeder holding stand 120 and storage case 140 of mounting device 22. In addition, horizontal moving device 182 includes X-direction guide rail 188, and X-direction guide rail 188 is held by pair of Z-direction guide rails 186 to extend in the X direction. X-direction guide rail 188 moves to any position in the Z direction by the driving of a Z direction motor (not illustrated). In addition, X-direction guide rail 188 holds clamp mechanism 184 to be movable along an axis of X-direction guide rail 188. Clamp mechanism 184 moves to any position in the X direction by driving of an X direction motor (not illustrated). Further, clamp mechanism 184 can expand and contract in the Y direction, and expands and contracts in the Y direction by driving of an expansion and contraction motor (not illustrated). Clamper 190 that clamps tape feeder 90 is provided at a distal end portion of clamp mechanism 184. With such a structure, feeder exchange device 26 automatically exchanges tape feeder 90 between tape feeder holding stand 120, storage case 140, and storage rack 160.

With the above-described configuration, in board work system 10, circuit board 57 is conveyed by conveyance device 30 inside five mounting devices 22, and the electronic components are mounted on circuit board 57 by mounting device 22. Specifically, first, circuit board 57 is carried into the mounting device disposed at the most upstream of five mounting devices 22. Then, in the mounting device, circuit board 57 is conveyed to a work position, and is fixedly held at the position. Tape feeder 90 mounted on tape feeder holding stand 120 feeds out taped component 98 and supplies the electronic component to the supply position. Then, mounting head 32 moves to the upper side of the supply position of the electronic component, and picks up and holds the electronic component by using suction nozzle 60. Subsequently, mounting head 32 moves to an upper side of circuit board 57, and mounts the held electronic component on the circuit board. In a case in which the mounting work of the electronic component on the circuit board ends, the circuit board is conveyed downstream and is carried into the mounting device disposed on the downstream side. The above-described mounting work is performed subsequently by each mounting device, and as a result, the circuit board on which the electronic components are mounted is manufactured.

In this manner, mounting devices 22 are configured to pick up and hold the electronic components supplied by tape feeder 90 by using suction nozzle 60 of mounting head 32, and mount the picked up and held electronic components on the circuit board. In mounting devices 22 configured as described above, for example, tape feeder 90 mounted on tape feeder holding stand 120 is exchanged by feeder exchange device 26 in order to respond replenishment, setup change, and the like of electronic components. That is, tape feeder 90 that is an exchange target is detached from tape feeder holding stand 120 by clamp mechanism 184 of feeder exchange device 26. Detached tape feeder 90 is stored in an empty slot of storage case 140 or storage rack 160. Subsequently, the tape feeder scheduled to be mounted on tape feeder holding stand 120 is clamped by clamp mechanism 184 of feeder exchange device 26 from storage case 140 or storage rack 160. Then, tape feeder 90 clamped by clamp mechanism 184 is mounted on tape feeder holding stand 120.

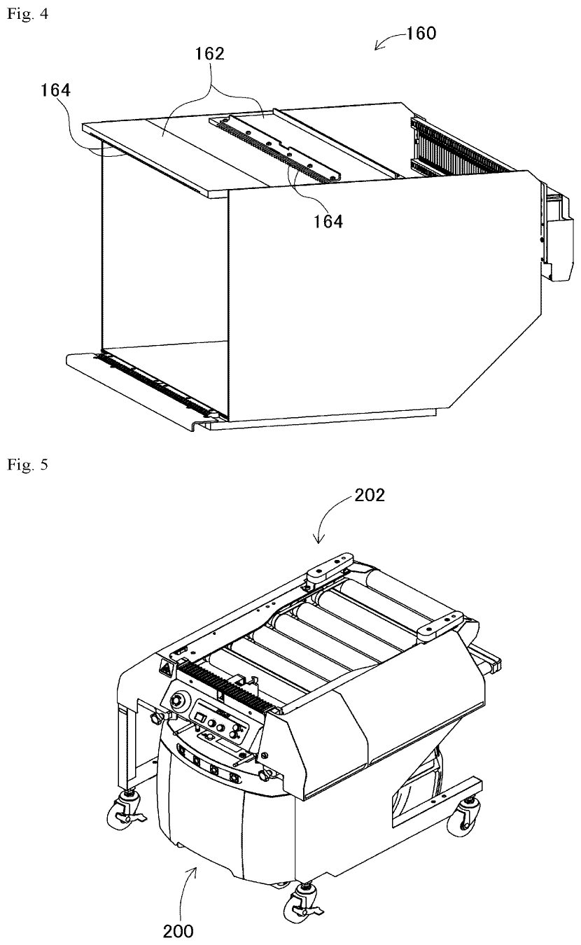

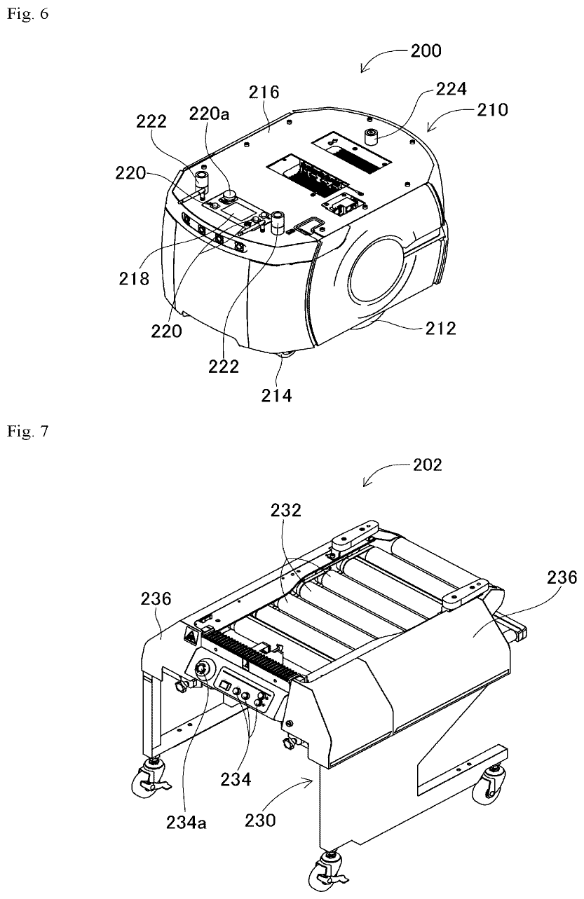

Therefore, tape feeder 90 that supplies the electronic components necessary for the replenishment, the setup change, and the like of the electronic components is stored in storage rack 160, and in board work system 10, storage rack 160 is automatically exchanged by automatic conveyance device 200 and conveyance cart 202 illustrated in FIG. 5. Specifically, as illustrated in FIG. 6, automatic conveyance device 200 includes pair of driving wheels (only one of the pair of driving wheels is illustrated) 212 disposed inside housing 210, and pair of turning wheels (only one of the pair of turning wheels is illustrated) 214. Accordingly, automatic conveyance device 200 can automatically move along any route. A side on which pair of turning wheels 214 are disposed is referred to as a front side, and a side on which pair of driving wheels 212 are disposed is referred to as a rear side.

Display monitor 218 is disposed in a central portion of a front side of top plate 216 of housing 210, and the operation state of automatic conveyance device 200 is displayed on display monitor 218. Multiple operation switches 220 are disposed on the left and right sides of display monitor 218. One operation switch of multiple operation switches 220 is emergency stop switch 220a for urgently stopping the operation of automatic conveyance device 200, and the operations of driving wheels 212 and turning wheels 214 are urgently stopped by operating emergency stop switch 220a. Pair of front side pins 222 are erected on the front side of top plate 216 of housing 210 to interpose display monitor 218 and multiple operation switches 220. Meanwhile, rear side pin 224 is erected at the center of the rear side of top plate 216 of housing 210.

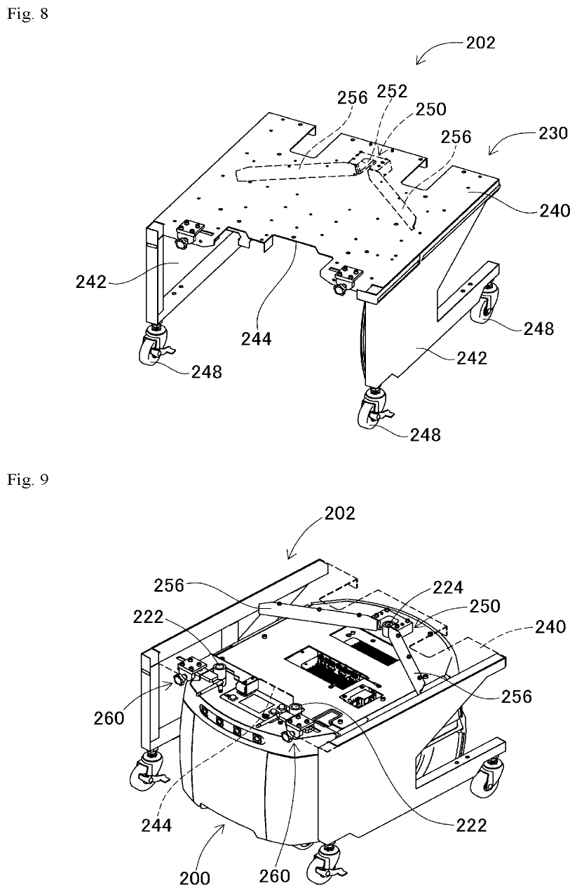

As illustrated in FIGS. 7 and 8, conveyance cart 202 includes base 230 having a gate shape, multiple conveyance rollers 232, multiple operation switches 234, and pair of covers 236. FIG. 8 is a perspective view of conveyance cart 202 in which multiple conveyance rollers 232, multiple operation switches 234, and covers 236 are omitted.

Base 230 includes top plate 240 having a substantially square shape and pair of support walls 242 that support top plate 240. Cutout portion 244 cut out in a substantially rectangular shape is formed on one side edge of top plate 240. A side of the side edge of top plate 240 on which cutout portion 244 is formed is referred to as a front side, and a side of a side edge of top plate 240 facing the side edge on which cutout portion 244 is formed is referred to as a rear side. Pair of support walls 242 are disposed to extend downward from a pair of side edges other than a front side edge and a rear side edge of top plate 240, that is, a pair of side edges on the left and right sides of top plate 240. Accordingly, base 230 has a gate shape that is open on the front side and the rear side. Pair of casters 248 are disposed on lower ends of support walls 242 on the front side and the rear side. Accordingly, base 230 can move to any position. An inner dimension between pair of support walls 242 of base 230 is slightly larger than a length dimension of automatic conveyance device 200 in a left-right direction. A length dimension of base 230 in the front-rear direction is slightly larger than the length dimension of automatic conveyance device 200 in the front-rear direction. A height dimension of a lower surface of top plate 240 of base 230 is slightly larger than a height dimension of automatic conveyance device 200.

Further, as illustrated in FIG. 7, multiple conveyance rollers 232 are disposed to be arranged in the front-rear direction in a posture extending in the left-right direction above top plate 240 of base 230. Each of multiple conveyance rollers 232 is rotatable about an axis extending in the left-right direction. Multiple conveyance rollers 232 rotate in any direction by driving of an electromagnetic motor (not illustrated).

Multiple operation switches 234 are disposed above top plate 240 of base 230 and on the front side of multiple conveyance rollers 232. One operation switch of multiple operation switches 234 is emergency stop switch 234a for urgently stopping the operation of conveyance cart 202, and the operations of conveyance rollers 232 are urgently stopped by operating emergency stop switch 234a. Further, pair of covers 236 are disposed to cover the pair of side edges on the left and right sides of top plate 240 of base 230, and multiple conveyance rollers 232 and multiple operation switches 234 are exposed from between pair of covers 236.

As illustrated in FIG. 8, pin accommodation tool 250 having a substantially U-shape is fixed to the lower surface of top plate 240 of base 230 at the center of the end portion on the rear side of top plate 240. Pin accommodation tool 250 having a substantially U-shape is open on the front side, and recessed portion 252 is formed from the opening toward the inside of pin accommodation tool 250. An inner dimension of recessed portion 252 is slightly larger than an outer diameter of rear side pin 224 of automatic conveyance device 200. Pair of guides 256 are fixed to the lower surface of top plate 240 to extend substantially in a V-shape from the left and right sides of the opening of recessed portion 252 of pin accommodation tool 250 to the obliquely front side of top plate 240. Further, cutout portion 244, which is cut out in a substantially rectangular shape, of top plate 240 is formed such that a longitudinal direction thereof extends in the left-right direction of top plate 240, and an inner dimension of cutout portion 244 in the left-right direction is slightly larger than a maximum separation distance between pair of front side pins 222 of automatic conveyance device 200. The maximum separation distance between pair of front side pins 222 is a distance obtained by adding a distance obtained by doubling a radius of front side pin 222 to a distance between a first axis and a second axis of pair of front side pins 222.

With such a structure, conveyance cart 202 is mounted in a state of being positioned with respect to automatic conveyance device 200. Specifically, for example, the worker causes the rear of automatic conveyance device 200 to enter from the front opening of conveyance cart 202. Then, automatic conveyance device 200 is caused to enter the inside of conveyance cart 202 until entire automatic conveyance device 200 is located below conveyance cart 202. In this case, as illustrated in FIG. 9, rear side pin 224 of automatic conveyance device 200 is guided to pair of guides 256 of conveyance cart 202 and is accommodated inside pin accommodation tool 250. Further, pair of front side pins 222 of automatic conveyance device 200 are positioned at corners of cutout portion 244 of conveyance cart 202. Therefore, conveyance cart 202 is mounted in a state of being positioned with respect to automatic conveyance device 200.

In addition, pair of lock mechanisms 260 are disposed on the front side edge of top plate 240 in conveyance cart 202, and pair of front side pins 222 of automatic conveyance device 200 are locked by pair of lock mechanisms 260 in a state in which conveyance cart 202 is mounted on automatic conveyance device 200. That is, conveyance cart 202 is locked to automatic conveyance device 200 by pair of lock mechanisms 260. Lock mechanism 260 will be described in detail later. When conveyance cart 202 is mounted on automatic conveyance device 200, conveyance cart 202 and automatic conveyance device 200 are electrically connected to each other, which will be described in detail later.

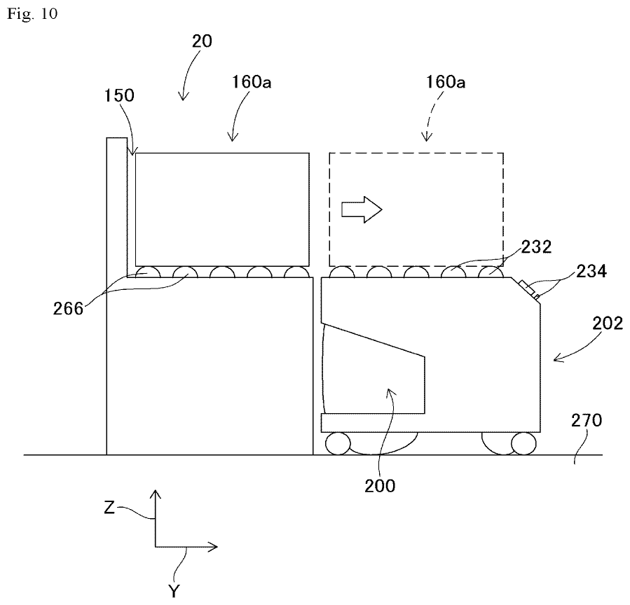

In this way, when conveyance cart 202 is mounted on automatic conveyance device 200 in a locked state, and conveyance cart 202 and automatic conveyance device 200 are electrically connected, storage rack 160 stored in feeder storage 20 is automatically exchanged by automatic conveyance device 200 and conveyance cart 202. Specifically, as illustrated in FIG. 10, a height of the lower surface of storage space 150 in which storage rack 160 of feeder storage 20 is stored is substantially the same as a height of the upper surface of conveyance cart 202 mounted on automatic conveyance device 200. On the lower surface of storage space 150, multiple conveyance rollers 266 are disposed to be arranged in the Y direction in a posture extending in the X direction. Each of multiple conveyance rollers 266 is rotatable about an axis extending in the X direction. Multiple conveyance rollers 266 rotate in any direction by driving of an electromagnetic motor (not illustrated).

With such a structure, in feeder storage 20, for example, storage rack 160 stored in storage space 150 is automatically transferred to conveyance cart 202 mounted on automatic conveyance device 200. Specifically, conveyance cart 202 mounted on automatic conveyance device 200 moves to a position facing storage space 150 in which a storage rack (hereinafter, referred to as “unnecessary rack 160a”) is accommodated, by operation of automatic conveyance device 200. In this case, conveyance cart 202 moves such that the rear side of conveyance cart 202 faces storage space 150. Then, multiple conveyance rollers 266 of feeder storage 20 rotate in a direction in which unnecessary rack 160a is carried out, and multiple conveyance rollers 232 of conveyance cart 202 rotate in a direction in which unnecessary rack 160a is carried in. Accordingly, unnecessary rack 160a stored in storage space 150 is automatically transferred to conveyance cart 202 mounted on automatic conveyance device 200.

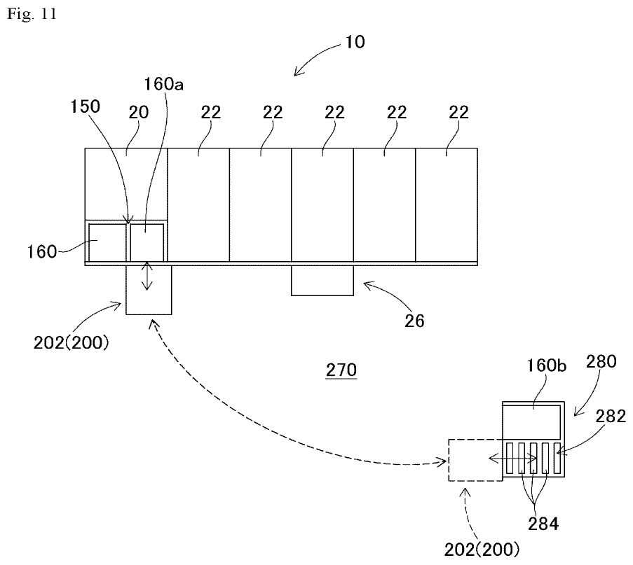

As illustrated in FIG. 11, rack management device 280 is also installed on floor 270 on which board work system 10 is installed. Rack management device 280 is a device that manages storage rack 160, and includes storage space 282 similarly to feeder storage 20, and can store two storage racks 160 side by side in storage space 282. In rack management device 280 illustrated in FIG. 11, one storage rack (hereinafter referred to as “necessary rack 160b”) is stored, and tape feeder 90 that supplies the electronic component scheduled to be mounted in mounting device 22 is stored in necessary rack 160b. A space adjacent to necessary rack 160b is an empty space. Similarly to storage space 150 of feeder storage 20, multiple conveyance rollers 284 are also disposed on a lower surface of storage space 282 of rack management device 280, and multiple conveyance rollers 284 also rotate in any direction by driving of an electromagnetic motor (not illustrated).

When unnecessary rack 160a is transferred from feeder storage 20 to conveyance cart 202, conveyance cart 202 moves to a position facing the empty space of rack management device 280 based on the operation of automatic conveyance device 200. Then, multiple conveyance rollers 232 of conveyance cart 202 rotate in a direction in which unnecessary rack 160a is carried out, and multiple conveyance rollers 284 of rack management device 280 rotate in a direction in which unnecessary rack 160a is carried in. Accordingly, unnecessary rack 160a placed on conveyance cart 202 is automatically transferred to storage space 282 of rack management device 280. Subsequently, conveyance cart 202 moves to a position facing necessary rack 160b stored in storage space 282 of rack management device 280 based on the operation of automatic conveyance device 200. Then, multiple conveyance rollers 284 of rack management device 280 rotate in a direction in which necessary rack 160b is carried out, and multiple conveyance rollers 232 of conveyance cart 202 rotate in a direction in which necessary rack 160b is carried in. Accordingly, necessary rack 160b accommodated in rack management device 280 is automatically transferred to conveyance cart 202.

Next, conveyance cart 202 to which necessary rack 160b is transferred moves to the empty space of feeder storage 20, that is, the position facing the space in which unnecessary rack 160a was placed, by the operation of automatic conveyance device 200. Then, multiple conveyance rollers 232 of conveyance cart 202 rotate in a direction in which necessary rack 160b is carried out, and multiple conveyance rollers 266 of feeder storage 20 rotate in a direction in which necessary rack 160b is carried in. Accordingly, necessary rack 160b placed on conveyance cart 202 is automatically transferred to storage space 150 of feeder storage 20.

In this way, unnecessary rack 160a stored in feeder storage 20 is automatically exchanged with necessary rack 160b by automatic conveyance device 200 and conveyance cart 202. For example, when conveyance cart 202 moves between feeder storage 20 and rack management device 280 by the operation of automatic conveyance device 200, when a trouble or the like occurs, the worker operates emergency stop switch 220a of automatic conveyance device 200. Accordingly, the operation of automatic conveyance device 200 is urgently stopped, and the movement of conveyance cart 202 mounted on automatic conveyance device 200 is stopped. As described above, conveyance cart 202 mounted on automatic conveyance device 200 is electrically connected to automatic conveyance device 200. Therefore, when emergency stop switch 234a of conveyance cart 202 is operated, an operation signal of emergency stop switch 234a is output from conveyance cart 202 to automatic conveyance device 200. In this case, automatic conveyance device 200 receives the operation signal of emergency stop switch 234a of conveyance cart 202. This is because when an abnormality occurs in conveyance cart 202 while conveyance cart 202 is being conveyed by automatic conveyance device 200, the conveyance of conveyance cart 202 by automatic conveyance device 200 needs to be stopped. This is also because when an abnormality occurs in conveyance cart 202 while storage rack 160 is being transferred by conveyance cart 202, the transfer operation of storage rack 160 is stopped, and in this case, it would be problematic if conveyance cart 202 is conveyed by automatic conveyance device 200. When automatic conveyance device 200 receives the operation signal of emergency stop switch 234a, the operation of automatic conveyance device 200 is urgently stopped. That is, when emergency stop switch 234a of conveyance cart 202 is operated while conveyance cart 202 is moving by the operation of automatic conveyance device 200, the operation of automatic conveyance device 200 is urgently stopped, and the movement of conveyance cart 202 is stopped. As described above, when conveyance cart 202 moves by the operation of automatic conveyance device 200, any one of emergency stop switch 234a of conveyance cart 202 or emergency stop switch 220a of automatic conveyance device 200 is operated to urgently stop the operation of automatic conveyance device 200 and stop the movement of conveyance cart 202.

When a trouble or the like occurs when storage rack 160 is transferred between feeder storage 20 and conveyance cart 202 or between conveyance cart 202 and rack management device 280, the worker operates emergency stop switch 234a of conveyance cart 202. Accordingly, the operation of conveyance cart 202 is urgently stopped, and the transfer of storage rack 160 between feeder storage 20 and conveyance cart 202 or between conveyance cart 202 and rack management device 280 is stopped. However, even when emergency stop switch 220a of automatic conveyance device 200 is operated while storage rack 160 is being transferred between feeder storage 20 and conveyance cart 202 or between conveyance cart 202 and rack management device 280, the transfer of storage rack 160 is not stopped. Specifically, conveyance cart 202 mounted on automatic conveyance device 200 is electrically connected to automatic conveyance device 200. However, for example, since automatic conveyance device 200 needs only to have a shape capable of conveying conveyance cart 202, a manufacturer of automatic conveyance device 200 may be different from a manufacturer of conveyance cart 202, and, in this case, it may be impossible to standardize conditions for outputting the emergency signal by automatic conveyance device 200. In addition, when an abnormality occurs in automatic conveyance device 200 while conveyance cart 202 is being conveyed by automatic conveyance device 200 other than the operation of emergency stop switch 220a by the worker, conveyance cart 202 is only being conveyed by automatic conveyance device 200, and thus it is not necessary to receive an emergency stop signal from automatic conveyance device 200. Further, when an abnormality occurs in automatic conveyance device 200 while storage rack 160 is being transferred by conveyance cart 202 other than the operation of emergency stop switch 220a by the worker, the transfer operation of storage rack 160 is executed by conveyance cart 202, and the emergency stop signal is not received from automatic conveyance device 200 to conveyance cart 202 so that the transfer operation of conveyance cart 202 is not interrupted by the stop of automatic conveyance device 200. For this reason, even when automatic conveyance device 200 and conveyance cart 202 are electrically connected, conveyance cart 202 does not receive the emergency stop signal output from automatic conveyance device 200. Therefore, even when emergency stop switch 220a of automatic conveyance device 200 is operated while storage rack 160 is being transferred, the transfer of storage rack 160 is not stopped. That is, during movement of conveyance cart 202, the movement of conveyance cart 202 is stopped when emergency stop switch 234a of conveyance cart 202 or emergency stop switch 220a of automatic conveyance device 200 is operated, but, during the transfer of storage rack 160, the transfer of storage rack 160 is not stopped unless emergency stop switch 234a of conveyance cart 202 is operated.

In this way, in a state in which conveyance cart 202 is mounted on automatic conveyance device 200, there are two emergency stop switches, emergency stop switch 234a of conveyance cart 202 and emergency stop switch 220a of automatic conveyance device 200, so that the worker may be confused as to which switch to operate when making an instant decision. Therefore, it is conceivable to eliminate emergency stop switch 220a of automatic conveyance device 200, but automatic conveyance device 200 may move in a state in which conveyance cart 202 is not mounted, and thus emergency stop switch 220a of automatic conveyance device 200 cannot be eliminated. In view of this, in conveyance cart 202, a member that shields emergency stop switch 220a of automatic conveyance device 200 in a state in which conveyance cart 202 is mounted on automatic conveyance device 200 is disposed in lock mechanism 260.

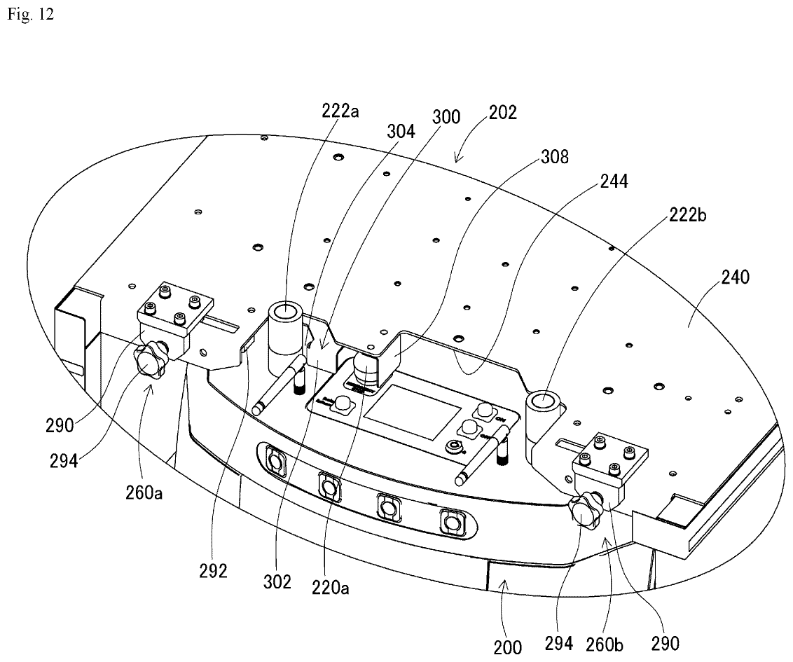

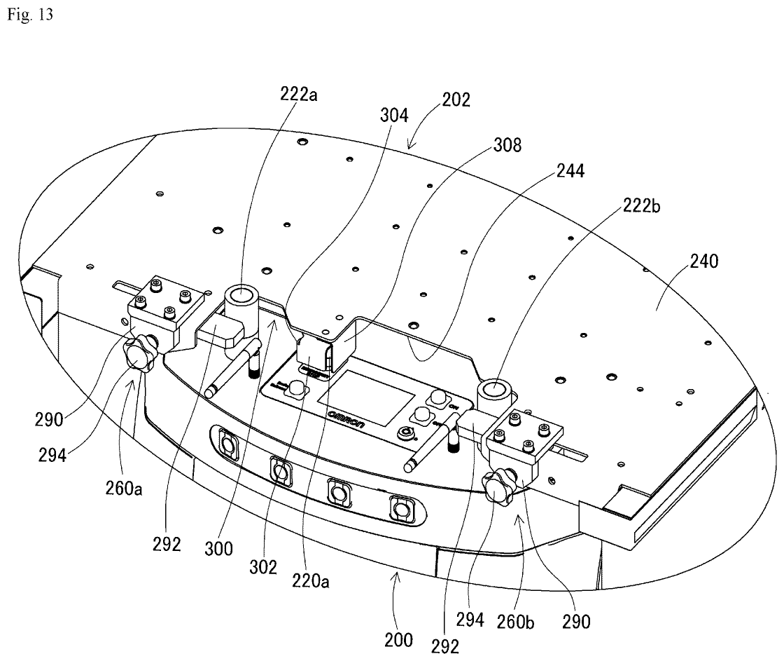

Specifically, as illustrated in FIGS. 12 and 13, pair of lock mechanisms 260 are disposed on the front side edge of top plate 240 of conveyance cart 202 to interpose cutout portion 244. Each of pair of lock mechanisms 260 includes slider 290, restriction plate 292, and stop screw 294. Slider 290 is slidably disposed on top plate 240 in the left-right direction, and slider 290 is fixed to top plate 240 by stop screw 294. Restriction plate 292 has a generally rectangular plate shape and is fixed to slider 290 such that a longitudinal direction thereof extends in the left-right direction of conveyance cart 202. Restriction plate 292 is fixed to slider 290 to extend into cutout portion 244 by sliding slider 290 toward cutout portion 244. Restriction plate 292 is fixed to slider 290 to be hidden under top plate 240 without extending into cutout portion 244 by sliding slider 290 in a direction away from cutout portion 244. With such a structure, sliders 290 of pair of lock mechanisms 260 are slid toward cutout portion 244 in a state in which conveyance cart 202 is mounted on automatic conveyance device 200, so that pair of restriction plates 292 are located in front of pair of front side pins 222 located at the corners of cutout portion 244 as illustrated in FIG. 13. Since slider 290 is fixed to top plate 240 by stop screw 294, the forward movement of pair of front side pins 222 is restricted by pair of restriction plates 292. Therefore, conveyance cart 202 in a state of being mounted on automatic conveyance device 200 is locked by pair of lock mechanisms 260. Further, by loosening stop screw 294 and sliding pair of sliders 290 in a direction away from cutout portion 244, as illustrated in FIG. 12, pair of restriction plates 292 move from the front of pair of front side pins 222 to the lower side of top plate 240. Accordingly, the lock of conveyance cart 202 to automatic conveyance device 200 is released.

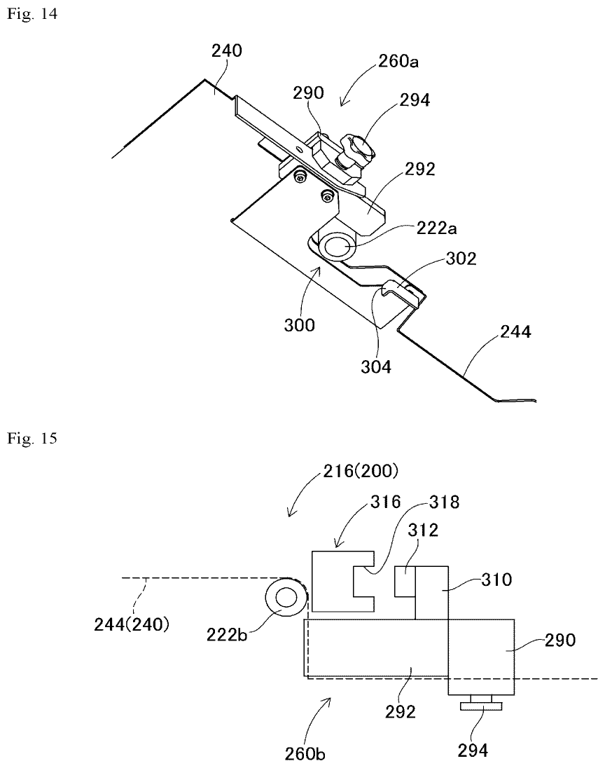

Shielding member 300 that shields emergency stop switch 220a of automatic conveyance device 200 is disposed in lock mechanism 260a disposed on the left side of pair of lock mechanisms 260 in FIGS. 12 and 13. Specifically, as illustrated in FIG. 14 illustrating lock mechanism 260a as viewed from below top plate 240, shielding member 300 has a generally L-shaped plate shape, and is fixed to restriction plate 292 to be substantially U-shaped with restriction plate 292. Shielding member 300 is fixed to restriction plate 292 such that front side pin 222a is located between restriction plate 292 and shielding member 300. A distal end of shielding member 300 extends further toward the inside of cutout portion 244 of top plate 240 compared to a distal end of restriction plate 292. A front side end portion of the distal end of shielding member 300 is bent at a substantially right angle toward the lower side, and serves as lower bent portion 302. Lower bent portion 302 is further bent at a substantially right angle toward the rear side on a base end side of shielding member 300, and serves as rear bent portion 304.

With such a structure, as illustrated in FIG. 13, when slider 290 of lock mechanism 260a is slid toward cutout portion 244, and restriction plate 292 moves forward of front side pin 222a, shielding member 300 moves toward cutout portion 244 in conjunction with lock mechanism 260a. In this case, lower bent portion 302 of shielding member 300 is located on a front side of emergency stop switch 220a of automatic conveyance device 200, and rear bent portion 304 of shielding member 300 is located on a left side of emergency stop switch 220a of automatic conveyance device 200. Accordingly, a front side and a left side of emergency stop switch 220a of automatic conveyance device 200 are shielded by lower bent portion 302 and rear bent portion 304 of shielding member 300. An upper side of emergency stop switch 220a of automatic conveyance device 200 is covered with top plate 240. Bracket 308 having an L-shape is fixed to top plate 240 to extend toward a right side of emergency stop switch 220a of automatic conveyance device 200. Accordingly, the upper side of emergency stop switch 220a of automatic conveyance device 200 is shielded by top plate 240, and the right side of emergency stop switch 220a of automatic conveyance device 200 is shielded by bracket 308. In this way, as shielding member 300 moves in conjunction with lock mechanism 260a, entire emergency stop switch 220a is shielded by shielding member 300, top plate 240, and bracket 308 in a state in which lock mechanism 260a locks conveyance cart 202.

Meanwhile, as illustrated in FIG. 12, when slider 290 of lock mechanism 260a is slid in a direction away from cutout portion 244, and restriction plate 292 moves from the front side of front side pin 222a to the lower side of top plate 240, shielding member 300 also moves in a direction away from emergency stop switch 220a in conjunction with lock mechanism 260a. In this case, lower bent portion 302 of shielding member 300 moves from the front side of emergency stop switch 220a, and rear bent portion 304 of shielding member 300 moves from the left side of emergency stop switch 220a. Therefore, the front side and the left side of emergency stop switch 220a of automatic conveyance device 200 are exposed. In this way, in a state in which conveyance cart 202 is mounted on and locked to automatic conveyance device 200, entire emergency stop switch 220a is shielded. Therefore, the worker cannot recognize emergency stop switch 220a of automatic conveyance device 200 and recognize only emergency stop switch 234a of conveyance cart 202 in conveyance cart 202 in a state of being mounted on and locked to automatic conveyance device 200 and automatic conveyance device 200. Accordingly, the worker can operate emergency stop switch 234a of conveyance cart 202 without being confused at emergency.

A member that electrically connects automatic conveyance device 200 and conveyance cart 202 is disposed in lock mechanism 260b disposed on the right side of pair of lock mechanisms 260 in FIGS. 12 and 13. Specifically, as illustrated in FIG. 15, support plate 310 is fixed to restriction plate 292 of lock mechanism 260b to extend rearward. Connector 312 is fixed to a distal end of support plate 310 in a posture in which connector 312 extends toward cutout portion 244 of top plate 240. Meanwhile, connector connection member 316 is disposed on a right side of front side pin 222b in top plate 216 of automatic conveyance device 200. Connector connection member 316 faces connector 312 fixed to restriction plate 292 of lock mechanism 260b via support plate 310, and connection portion 318 in accordance with a shape of connector 312 is formed at a position facing connector 312.

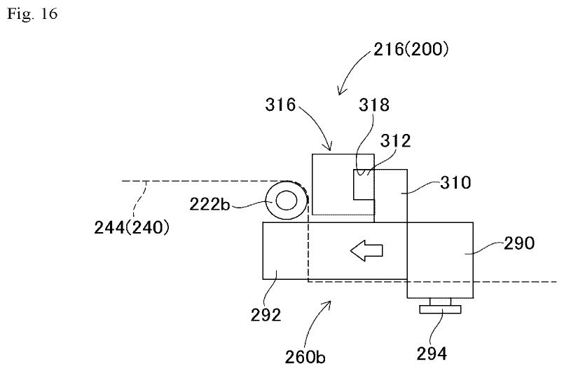

With such a structure, as illustrated in FIG. 15, when slider 290 of lock mechanism 260b is slid in a direction away from cutout portion 244, and restriction plate 292 is located below top plate 240, connector 312 faces connection portion 318 of connector connection member 316 of automatic conveyance device 200, and is not connected to connection portion 318. That is, in a state in which conveyance cart 202 is mounted on automatic conveyance device 200 but is not locked, connector 312 of conveyance cart 202 is not connected to connector connection member 316 of automatic conveyance device 200, and automatic conveyance device 200 and conveyance cart 202 are not electrically connected to each other. As illustrated in FIG. 16, when slider 290 of lock mechanism 260b is slid toward cutout portion 244, and restriction plate 292 moves forward of front side pin 222b, connector 312 also moves toward front side pins 222b in conjunction with lock mechanism 260a. In this case, connector 312 of conveyance cart 202 is engaged with connection portion 318 of automatic conveyance device 200 and is connected to connector connection member 316. That is, in a state in which conveyance cart 202 is mounted on and locked to automatic conveyance device 200, connector 312 of conveyance cart 202 is connected to connector connection member 316 of automatic conveyance device 200, so that automatic conveyance device 200 and conveyance cart 202 are electrically connected to each other.

By electrically connecting automatic conveyance device 200 and conveyance cart 202 in a state in which conveyance cart 202 is mounted on and locked to automatic conveyance device 200 in this manner, it is possible to ensure the operation of emergency stop switch 234a of conveyance cart 202. Specifically, as described above, by electrically connecting automatic conveyance device 200 and conveyance cart 202, when emergency stop switch 234a of conveyance cart 202 is operated, the operation signal of emergency stop switch 234a is output from conveyance cart 202 to automatic conveyance device 200. When automatic conveyance device 200 receives the operation signal of emergency stop switch 234a, the operation of automatic conveyance device 200 is urgently stopped. Therefore, when automatic conveyance device 200 and conveyance cart 202 are not electrically connected to each other, even when emergency stop switch 234a of conveyance cart 202 is operated, the operation of automatic conveyance device 200 is not stopped. In particular, when emergency stop switch 220a of automatic conveyance device 200 is shielded by shielding member 300, emergency stop switch 220a cannot be operated, so that the operation of automatic conveyance device 200 cannot be stopped. In view of this, connector 312 of conveyance cart 202 is disposed in lock mechanism 260b, and conveyance cart 202 is locked to automatic conveyance device 200 by lock mechanism 260b, so that connector 312 of conveyance cart 202 is always connected to connector connection member 316 of automatic conveyance device 200. Accordingly, when conveyance cart 202 is locked to automatic conveyance device 200 by lock mechanism 260b, automatic conveyance device 200 and conveyance cart 202 are always electrically connected to each other, so that the operation of emergency stop switch 234a of conveyance cart 202 is reliably ensured.

In the above-described embodiment, automatic conveyance device 200 is an example of an automatic conveyance device. Conveyance cart 202 is an example of an attachment device. Emergency stop switch 220a is an example of a structural member. Emergency stop switch 234a is an example of an attachment device side operation switch. Top plate 240 is an example of a shielding member. Lock mechanism 260 is an example of a lock mechanism. Shielding member 300 is an example of a shielding member. Bracket 308 is an example of a shielding member. Connector 312 is an example of a connection member.

The present embodiment, which has been described heretofore, provides the following effects.

In conveyance cart 202 in a state of being mounted on automatic conveyance device 200, emergency stop switch 220a of automatic conveyance device 200 is shielded by shielding member 300, top plate 240, and bracket 308. Thus, in a state in which conveyance cart 202 is mounted on automatic conveyance device 200, for example, it is possible to hide emergency stop switch 220a that may confuse the operation of the worker.

In addition, shielding member 300 moves between a position where shielding member 300 shields emergency stop switch 220a of automatic conveyance device 200 and a position where shielding member 300 exposes emergency stop switch 220a, in a state of being mounted on automatic conveyance device 200. Therefore, it is possible to desirably change the shielding and the exposure of emergency stop switch 220a.

Shielding member 300 moves in conjunction with lock mechanism 260a, and shields emergency stop switch 220a of automatic conveyance device 200 in a state in which lock mechanism 260a locks conveyance cart 202. Accordingly, emergency stop switch 220a can be shielded by shielding member 300 by locking conveyance cart 202 to automatic conveyance device 200 by lock mechanism 260a without intentionally moving shielding member 300.

Connector 312 electrically connected to automatic conveyance device 200 is disposed on conveyance cart 202. Connector 312 moves in conjunction with lock mechanism 260b, and is connected to connector connection member 316 of automatic conveyance device 200 in a state in which lock mechanism 260b locks conveyance cart 202. Accordingly, the worker does not forget the connection between connector 312 and connector connection member 316, and automatic conveyance device 200 and conveyance cart 202 can be reliably electrically connected to each other.

Emergency stop switch 220a of automatic conveyance device 200 is a switch for urgently stopping the operation of automatic conveyance device 200, and emergency stop switch 234a for urgently stopping the operation of automatic conveyance device 200 is disposed in conveyance cart 202. Accordingly, even in a state in which emergency stop switch 220a of automatic conveyance device 200 is shielded by shielding member 300, the operation of automatic conveyance device 200 can be urgently stopped by operating emergency stop switch 234a of conveyance cart 202.

The present disclosure is not limited to the above-described example, but can be carried out in various forms in which various changes and improvements are made based on the knowledge of those skilled in the art. Specifically, for example, in the above-described embodiment, conveyance cart 202 includes casters 248 and is configured to travel together with automatic conveyance device 200 in a state of being mounted on automatic conveyance device 200. Meanwhile, the attachment device to be attached to automatic conveyance device 200 may be a device that does not include wheels and is attached to automatic conveyance device 200 to be conveyed by the operation of automatic conveyance device 200. Further, the attachment device may be attached in a state of being placed on the upper surface of automatic conveyance device 200 or may be attached in a state of being hooked on the side surface of automatic conveyance device 200.

In the above-described example, emergency stop switch 220a is shielded by shielding member 300, top plate 240, and bracket 308, but emergency stop switch 220a may be shielded by top plate 240 and bracket 308 without using shielding member 300. That is, instead of movable shielding member 300, emergency stop switch 220a may be shielded by fixed top plate 240 and bracket 308 which are not movable. Further, emergency stop switch 220a may be shielded by shielding member 300 without using top plate 240 and bracket 308. That is, emergency stop switch 220a may be shielded by movable shielding member 300 instead of fixed top plate 240 and bracket 308.

In the above-described example, shielding member 300 interlocking with lock mechanism 260a is employed, but shielding member 300 not interlocking with lock mechanism 260a may be employed. That is, only shielding member 300 may be configured to slide between the position for shielding emergency stop switch 220a and the position for exposing emergency stop switch 220a without fixing shielding member 300 to restriction plate 292 of lock mechanism 260a.

In the above-described example, emergency stop switch 220a is shielded by shielding member 300, but the configuration is not limited to emergency stop switch 220a, and an operation switch for causing automatic conveyance device 200 to execute a predetermined operation, for example, an operation of mode switching, light turning-on, or the like may be shielded by shielding member 300.

However, in the above-described example, emergency stop switch 220a is shielded by shielding member 300, but display monitor 218 may be shielded. In such a case, it is preferable to dispose a display monitor that displays the operation state of automatic conveyance device 200, on conveyance cart 202.

In the above-described example, lock mechanism 260 is disposed on conveyance cart 202, but may be disposed in automatic conveyance device 200. When lock mechanism 260 is disposed in automatic conveyance device 200 as described above, lock mechanism 260 comes into contact with the shielding member disposed on conveyance cart 202 as lock mechanism 260 slides or the like, so that the shielding member moves in conjunction with lock mechanism 260.

In the above-described example, storage rack 160 that stores tape feeder 90 is conveyed by conveyance cart 202, but the configuration is not limited to storage rack 160, and various members may be conveyed by conveyance cart 202. Specifically, for example, a tray magazine that stores a tray for placing a component, a mask magazine that stores a mask used for solder printing, a substrate magazine that stores a board, and the like may be further conveyed by conveyance cart 202.

### REFERENCE SIGNS LIST

200: automatic conveyance device, 202: conveyance cart (attachment device), 220a: emergency stop switch (structural member), 234a: emergency stop switch (attachment device side operation switch), 240: top plate (shielding member), 260: lock mechanism, 300: shielding member, 308: bracket (shielding member), 312: connector (connection member)

1. An attachment device to be detachably attached to an automatic conveyance device, the attachment device comprising:
a shielding member configured to shield a structural member configured to operate or display an operation state of the automatic conveyance device in a state in which the attachment device is attached to the automatic conveyance device.

2. The attachment device according to claim 1, wherein the shielding member is configured to move between a position where the shielding member shields the structural member and a position where the shielding member exposes the structural member.

3. The attachment device according to claim 2,
wherein the attachment device or the automatic conveyance device includes a lock mechanism configured to lock the attachment device in a state in which the attachment device is attached to the automatic conveyance device, and
the shielding member moves in conjunction with the lock mechanism, and moves to the position where the shielding member shields the structural member in a state in which the lock mechanism locks the attachment device.

4. The attachment device according to claim 3,
wherein the attachment device includes a connection member configured to be electrically connected to the automatic conveyance device, and
the connection member moves in conjunction with the lock mechanism, and is electrically connected to the automatic conveyance device in a state in which the lock mechanism locks the attachment device.

5. The attachment device according to Claim 1,
wherein the structural member is an operation switch configured to cause the automatic conveyance device to execute a predetermined operation, and
the attachment device includes an attachment device side operation switch configured to cause the automatic conveyance device to execute the predetermined operation.
